(19) United States
(12) Patent Application Publication
(10) Pub. No.: US 2026/0208713 A1
(43) Pub. Date: Jul. 23, 2026

(54) BRAKE UNIT HAVING A FLUID RESERVOIR

(71) Applicant: Aumovio Germany GmbH, Frankfurt am Main (DE)

(72) Inventors: Joseph Dolmaya, Langen (DE); Mike Hirsemann, Darmstadt (DE); Martin Schott, Marburg (DE); Rüdiger Briesewitz, Bruchkoebel (DE); Marco Müller, Lahnau (DE)

(73) Assignee: Aumovio Germany GmbH, Frankfurt am Main (DE)

(21) Appl. No.: 19/571,618

(22) Filed: Mar. 19, 2026

Related U.S. Application Data
(62) Division of application No. 18/290,770, filed on Jan. 20, 2024.

(30) Foreign Application Priority Data
Jul. 20, 2021 (DE) 10 2021 207 762.5

(51) Int. Cl. B60T 11/26; B60T 17/06

(52) U.S. Cl. CPC B60T 11/26; B60T 17/06

(57) ABSTRACT

A brake unit for a hydraulic brake system of a vehicle, having at least one fluid reservoir for the supply of a hydraulic pressure medium to the brake unit. The brake unit having a housing with at least one receiving seat for receiving a connector piece formed on the fluid reservoir, and at least one form-fitting fastening point provided for securing the fluid reservoir in position relative to the housing, the fastening point including at least one reservoir interface formed on the fluid reservoir, and at least one counterpart interface situated outside the fluid reservoir. In order to design an improved fastening interface which is positioned so as to be subjected to reduced load and which can be used with particularly compact and highly integrated hydraulic assemblies, it is proposed that the counterpart interface is arranged on a separate installation component connected to the housing.

### CROSS REFERENCE TO RELATED APPLICATIONS

This application is the divisional of US Patent Application No. 18/290,770, filed January 20, 2024, which claims priority to National Stage Application under 35 U.S.C. § 371 of International Patent Application No. PCT/DE2022/200127 filed on June 13, 2022, and claims priority from German Patent Application No. 10 2021 207 762.5 filed on July 20, 2021, in the German Patent and Trademark Office, the disclosures of which are herein incorporated by reference in their entireties.

### FIELD OF THE INVENTION

The invention relates to a brake unit for a hydraulic brake system of a vehicle, having a fluid reservoir.

### BACKGROUND OF THE INVENTION

Fluid reservoirs are used for the supply of pressure medium to hydraulic assemblies in vehicles, such as brake units for hydraulic motor vehicle brake systems. Such fluid reservoirs are normally connected to the housing of the assembly by means of one or more connector pieces that are jammed into corresponding receiving seats by means of elastic sealing elements. Such force-fitting compression joints cannot adequately reliably accommodate the forces that arise during operation and in particular during the initial pressurized filling operation. It is therefore known, and routine practice, to additionally force-fittingly connect the fluid reservoir to the housing of the assembly at a separate fastening point.

For example, DE 102017215833 A1, incorporated herein by reference, has disclosed such a fastening device for fixing a fluid reservoir to a master brake cylinder. For fixing purposes, a securing pin is passed and fixed, transversely with respect to the installation direction of the fluid reservoir, through a passage opening formed directly in the housing of the master cylinder and through two fastening protrusions, which flank said passage opening, of the fluid reservoir. Here, the passage opening is normally positioned between two receiving seats in a longitudinal direction.

Modern master brake cylinders are of ever more compact construction, and it is furthermore sought for these to protrude as little as possible into the engine compartment from the bulkhead. As a result of this, filling ports of the fluid reservoir are offset a great distance forward in a longitudinal direction relative to the connector pieces in order to be made more easily accessible. This results in a strong lever action, as a result of which the fastening points and in particular the associated interfaces on the fluid reservoir are subjected to particularly high load when force is exerted at the filling port.

Furthermore, ever more highly integrated brake units are being used, which, aside from simply generating pressure, also perform pressure modulation and further functions. Housings of such brake units are designed as a hydraulic block, the interior of which is densely populated with a large number of hydraulic channels, connections, valves and sensors and connections. In such a hydraulic block, it is often very difficult, or even impossible, to integrate a favorable position for a form-fitting fastening point of the fluid reservoir.

An aspect of the present invention proposes an improved solution for the fastening of a fluid reservoir that can be used with particularly compact and highly integrated hydraulic assemblies, wherein it is sought for the load on the fastening point to be reduced as far as possible.

An aspect of the invention provides for a counterpart interface of the fastening point to be arranged on a separate installation component that is connected to the housing. The position for the fastening point can thus be selected, independently of the internal structure of the housing, in such a way as to optimize forces and reduce loads.

In order for the brake unit to have an effective construction and to be efficient to produce, the installation component can be provided for the installation of the brake unit on the vehicle.

In a further optimized design of the fastening point, the filling port and the reservoir interface may be arranged substantially at opposite ends of the fluid reservoir along a longitudinal axis that is oriented transversely with respect to the insertion direction of the connector piece, whereby the load on the fastening point is reduced owing to an optimum lever ratio.

For quick, secure and efficient locking, the fastening point may preferably be secured by means of a securing element which can be passed through the counterpart interface in a transverse direction and which, in a locked position, is engaged with detent action in a detent seat formed on the reservoir interface, wherein the engagement with detent action in the detent seat is preferably reversibly releasable.

In one preferred embodiment, the detent seat may be configured to receive a detent portion, which in the locked position is oriented spatially along the transverse axis, of the securing element, wherein, for straightforward installation by insertion in a rectilinear movement, the detent seat may particularly preferably be aligned with the counterpart interface.

In another particularly compact embodiment, the detent seat may also be configured to receive a detent portion, which in the locked position is oriented spatially along the longitudinal axis, of the securing element, which is advantageous in particular in the case of an installation space which is constricted laterally with respect to the fastening point.

In several further, particularly robust embodiments, the fastening point may likewise be secured by means of a securing element which is configured as a screw and which interacts with a thread arranged in the counterpart interface.

According to an aspect of the invention, a particularly effective construction can be realized if the installation component is designed as a flange element which is mechanically connected to the housing and which comprises at least one installation interface for a screw connection for the purposes of fastening to the vehicle.

### BRIEF DESCRIPTION OF THE DRAWINGS

Further features and advantages of aspects of the invention will become apparent from the following description. In the appended drawings:

FIG. 1 is a highly simplified illustration, not to scale, of the construction of the brake unit and of its arrangement in the vehicle.

FIG. 2 shows a first exemplary embodiment of the fastening device having a transverse pin, in two three-dimensional views (a, b).

FIG. 3 is a simplified cross-sectional illustration of the fastening device as per FIG. 1.

FIG. 4 shows three-dimensional views of a second exemplary embodiment of the fastening device having an angled pin, in a pre-installation position (a) and in a locked end position (b).

FIG. 5 shows three-dimensional views of a third exemplary embodiment of the fastening device having a U-shaped pin, in a pre-installation position (a) and in a locked end position (b).

FIG. 6 shows three-dimensional views of three further exemplary embodiments of the fastening device having a screw connection with differently oriented screws (a, b, c).

### DETAILED DESCRIPTION OF EXEMPLARY EMBODIMENTS

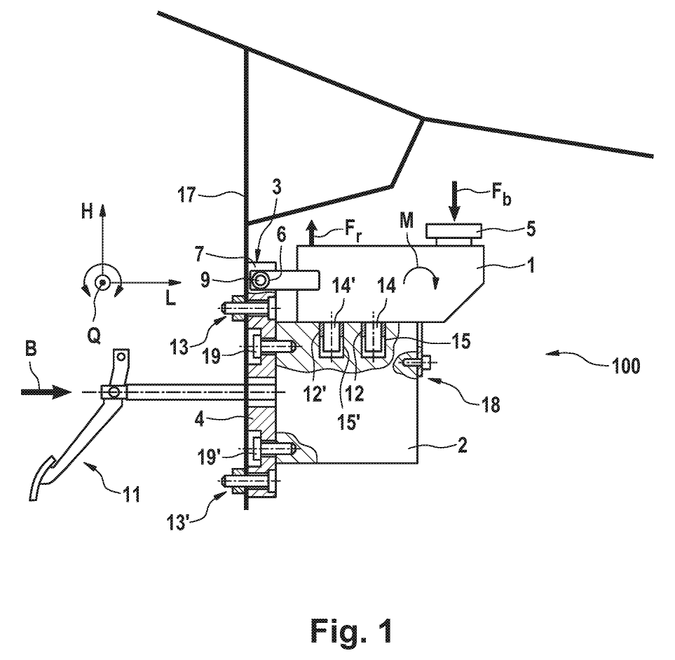

FIG. 1

FIG. 1 is a highly simplified diagrammatic illustration, not to scale, of a brake unit 100 according to an aspect of the invention for a hydraulic motor vehicle brake system, said brake unit having been installed in a vehicle.

The illustrated brake unit 100 is directly actuated by a driver via a mechanical actuating member 11. This however limits options for the positioning of the brake unit 100 in the engine compartment to a specified position on a bulkhead 17.

The brake unit 100 that is illustrated has a cuboidal housing 2 designed as a valve block. As viewed along a vertical axis H, a fluid reservoir 1 is positioned on the housing 2, which fluid reservoir serves for the supply of a hydraulic pressure medium to the brake unit 100. For this purpose, two connector pieces 14, 14' are formed on the fluid reservoir 1. The connector pieces 14, 14' are inserted along a vertical axis H into corresponding receiving seats 15, 15' in the housing 2 and are sealed and jammed therein by means of elastic sealing elements 12, 12'.

Owing to a shallow angle of inclination of the windshield, such as is common in modern motor vehicles, there is a pronounced overhang above the installation site of the brake unit 100, which overhang impedes the filling of the fluid reservoir 1.

A filling port 5 provided for the filling of the fluid reservoir 1 must therefore be offset by a relatively great distance in a longitudinal direction L.

The initial filling of the brake system at the vehicle factory is normally performed using a special filling installation in a so-called pressurized filling operation. Here, a special coupling (not illustrated here) is sealingly attached to the filling port, whereupon a negative pressure is generated in the brake system and the hydraulic pressure medium or brake fluid is drawn in abruptly via the filling port 5. A relatively high force Fb acts on the fluid reservoir 1 in particular when the coupling is attached, said force being directed counter to the vertical axis H. The fact that the filling port 5 is situated relatively far forward results in a strong lever action and in a relatively high torque M about the transverse axis Q. This could cause the connector pieces 12, 12' to disengage from their receiving seats 15, 15'.

In order to effectively prevent this, a form-fitting fastening point 3 is provided on the brake unit 100. In order to keep the load on the fastening point 3 low, said fastening point is arranged at an opposite end of the fluid reservoir 1 in the longitudinal direction L in relation to the filling port 5, because it is there that the resultant force Fr acting in the direction of the vertical axis H is lowest owing to the favorable lever ratio.

The fastening point 3 comprises a reservoir interface 6 which is formed on the fluid reservoir 1 and which is assigned to a corresponding counterpart interface 7 outside the fluid reservoir 1. The two interfaces 6, 7 are connected by means of a separate pin-like securing element 9 that is inserted transversely with respect to the insertion direction of the fluid reservoir or with respect to the vertical axis H, resulting in a secure form fit and preventing connector pieces 14, 14' from being disengaged by lever action.

In order that the housing 2 can be made as lightweight and compact as possible and at the same time can be produced as efficiently and inexpensively as possible, the flange for the installation of the brake unit 100 on the bulkhead 17 is formed as a separate installation component 4. The installation component 4 has corresponding installation interfaces 13, 13' for the installation of the brake unit 100 on the bulkhead 17, and is at the same time mechanically connected by means of connecting elements 19, 19' to the housing 2. In the embodiment shown, the installation interfaces 13, 13' are provided, by way of example, as conventional threaded bolts that are inserted, so as to be secured against rotation, into the installation component 4.

The counterpart interface 7 of the fastening point 3 is in this case formed on the installation component 4, such that the fluid reservoir 1 is fastened simultaneously to the housing 2 and to the installation component 4.

In the embodiment shown, the brake unit 100 has an additional, second fastening point 18. Said second fastening point is positioned as a simple screw connection at the filling-port-side end of the housing 2 and is provided substantially for accommodating vibrations and forces that act upwardly on the fluid reservoir 1. Such forces may arise for example during driving operation on uneven road surfaces.

Note that a bulkhead 17 in a motor vehicle is often slightly inclined relative to the vertical axis H of the vehicle, as a result of which the longitudinal axis L, the vertical axis H and the transverse axis Q of the fluid reservoir 1 may in practice correspond not exactly, but at least approximately, to the longitudinal, vertical and transverse axes of the vehicle.

Different axis assignments however remain admissible within the scope of an aspect of the invention.

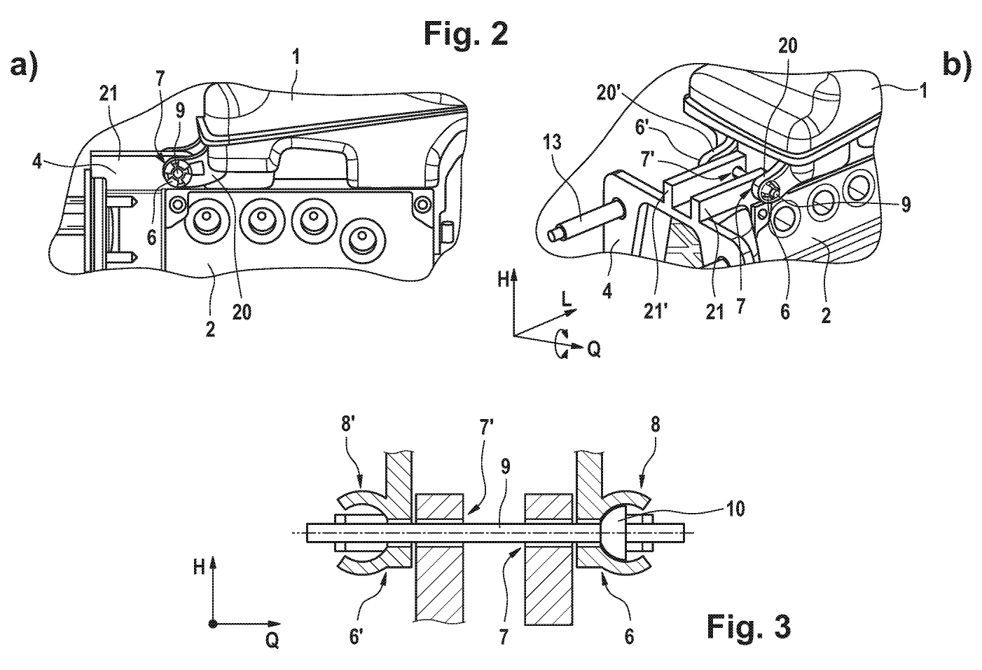

FIG. 2

FIG. 2 shows a first exemplary embodiment having a preferred embodiment of the fastening device 3 in two three-dimensional views.

The reservoir interfaces 6, 6' are arranged on fastening lugs 20, 20' on the fluid reservoir 1, whereas the counterpart interfaces 7, 7' are positioned on rib-like projections 21, 21' of the installation component 4. A pin-like securing element 9 is passed in a transverse direction through corresponding passage openings of reservoir interfaces 6, 6' and counterpart interfaces 7, 7' and is secured against falling out.

FIG. 3

FIG. 3 shows the fastening point 3 as per the embodiment according to FIG. 2 in cross section.

In each case one detent seat 8, 8' is arranged, in alignment with the counterpart interfaces 7, 7', at the reservoir interfaces 6, 6'. The pin-like securing element 9 has, at one end, a detent portion 10 that is designed to engage with detent action in the detent seat 8 or 8'. In the embodiment illustrated, the detent portion 10 is designed as a hemispherical thickened portion of the securing element 9 and is encompassed by multiple elastic spring lugs of the detent seat 8. The securing element 9 is thus held securely in the locked position illustrated here, but can be pulled out without damage, and thus fully reversibly, by virtue of a corresponding force being applied.

Furthermore, owing to the symmetrical construction of the preferred embodiment of the fastening point 3 illustrated, the securing element 9 can be inserted from both sides, thus enabling the same components to be used for right-hand-drive and left-hand-drive vehicles, for example.

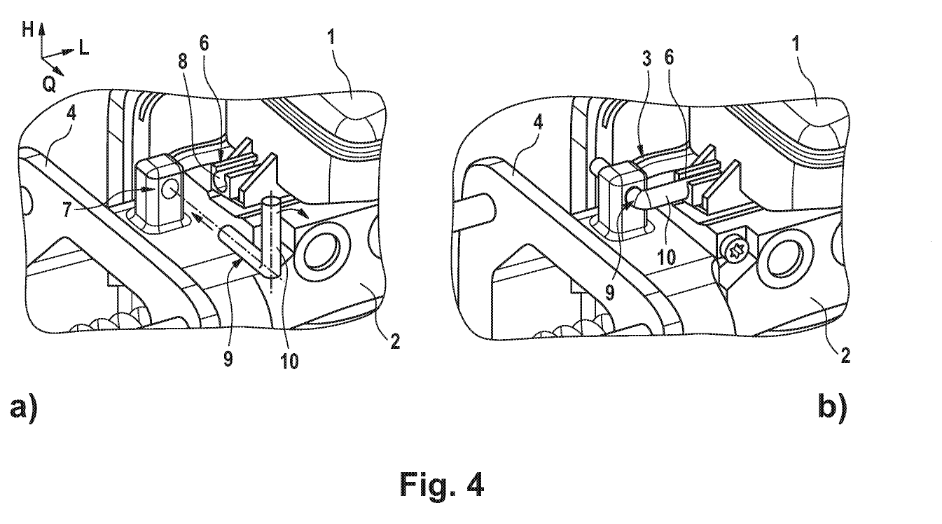

FIG. 4

FIG. 4 shows a second embodiment of the fastening point 3. The counterpart interface 7 is designed as a passage opening, oriented parallel to the transverse axis Q, in a projection 21 on the installation component 4. The securing element 9 is of L-shaped design. In order to fix the fluid reservoir 1, the securing element 9 is inserted into the counterpart interface 7 along the transverse axis Q and is rotated about the transverse axis Q toward the fluid reservoir 1. Here, the detent portion 10 is clipped or engaged with detent action into an elongate, trough-like detent seat 8, oriented along the longitudinal axis L, of the reservoir interface 6.

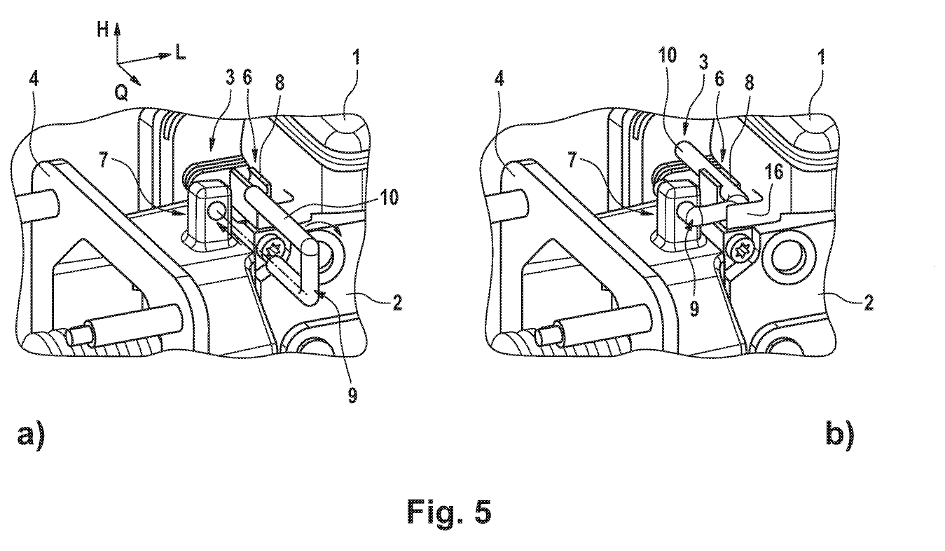

FIG. 5

FIG. 5 shows a third embodiment of the fastening point 3. The securing element 9 is in this case of U-shaped design. The detent seat 8 on the reservoir interface 6 is of elongate, trough-like form, similarly to the embodiment according to FIG. 4, but is oriented parallel to the insertion direction or transverse axis Q. As in the embodiment according to FIG. 4, the securing element is inserted in the transverse direction into the counterpart interface 7, is rotated toward the fluid reservoir 1 and is engaged with detent action, by way of the detent portion 10, in the detent seat 8. A stop surface 16 is formed on the reservoir interface 6 in order to reliably prevent the securing element 9 from falling out, which stop surface prevents the securing element 9 from sliding out counter to its insertion direction when it is in the locked position.

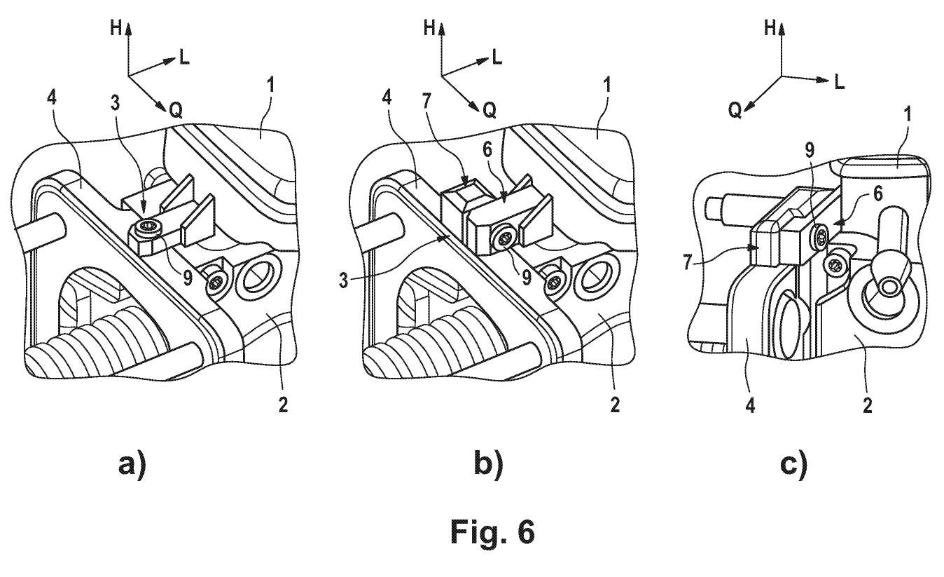

FIG. 6

FIG. 6 shows three other embodiments of the fastening point 3. By contrast to the embodiments described above, the securing element 9 is provided as a screw that is screwed into a threaded bore (not explicitly illustrated here) formed in the counterpart interface 7.

As is apparent from the views 6a, 6b and 6c, the scope of an aspect of the invention allows for the securing element 9 to be oriented along all spatial axes.

### Reference signs

1 Fluid reservoir

2 Housing

3 Fastening point

4 Installation component

5 Filling port

6 Reservoir interface

7 Counterpart interface

8 Detent seat

9 Securing element

10 Detent portion

11 Actuating member

12 Sealing element

13 Installation interface

14 Connector piece

15 Receiving seat

16 Stop surface

17 Bulkhead

18 Fastening point

19 Connecting element

20 Fastening lug

21 Projection

100 Brake unit

M Torque

B Actuating direction

Fb Force during pressurized filling

Fr Resultant force

H Vertical axis

L Longitudinal axis

Q Transverse axis

1. A brake unit for a hydraulic brake system of a vehicle, the brake unit comprising:
at least one fluid reservoir comprising at least one connector formed thereon;
a housing comprising at least one receiving seat formed therein;
wherein:
the at least one fluid reservoir adapted to supply a hydraulic pressure medium to the housing, and
the housing adapted to receive the at least one connector of the fluid reservoir into a respective one of the at least one receiving seat of the housing;
at least one form-fitting fastening point for securing the fluid reservoir in position relative to the housing, wherein the fastening point comprises at least one reservoir interface formed on the fluid reservoir and at least one counterpart interface situated outside the fluid reservoir;
wherein the counterpart interface is part of a separate installation component that is adapted to be coupled to the housing, and
wherein the fastening point is secured with a screw which interacts with a thread arranged in the counterpart interface.

2. The brake unit as claimed in claim 1, wherein the separate installation component is provided for the installation of the brake unit on the vehicle.

3. The brake unit as claimed in claim 1, wherein the fluid reservoir further comprises a filling port for filling the fluid reservoir with the hydraulic pressure medium, the filling port and the reservoir interface being arranged substantially at opposite ends of the fluid reservoir along a longitudinal axis that is oriented transversely with respect to the insertion direction of the connector piece.

4. The brake unit as claimed in claim 1, wherein the separate installation component is a flange element which is mechanically connected to the housing and which comprises at least one installation interface for a screw connection for the purpose of fastening the brake unit to the vehicle.
